(19) United States
(12) Patent Application Publication
(10) Pub. No.: US 2010/0115468 A1
(43) Pub. Date: May 6, 2010

(54) SYSTEM AND METHOD FOR HIERARCHICAL ELECTRONIC FILE NAVIGATION FROM A PROCESSING DEVICE FRONT PANEL

(76) Inventor: Marianne L. KODIMER, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/265,999

(22) Filed: Nov. 6, 2008

(51) Int. Cl. G06F 3/048; G06F 17/30

(52) U.S. Cl. 715/838; 707/E17.01; 707/E17.008

(57) ABSTRACT

The subject application is directed to a system and method for hierarchical electronic file navigation. Electronic files, of documents or folders, are first stored in an associated data storage. Upon receipt of user identification, a default subset of stored files is retrieved and indicia corresponding to the files are displayed to an associated user. The files are displayed with a folder icon or a document thumbnail image. Selection data is then received of a selected electronic folder listed on the display and indicia are generated on the display corresponding to contents of electronic files of the selected document folder. Shortcut selection data is received from the user corresponding to at least one selected electronic file and the at least one selected electronic file is added to the default listing in accordance with received shortcut selection data.

### BACKGROUND OF THE INVENTION

The subject application is directed generally to file navigation via a graphical user interface. The application is particularly applicable to file navigation for efficient file selection and folder selection in connection with document processing devices.

Document processing devices include copies, printers, facsimile machines, scanners and electronic mail clients. More recently, two or more of these functions are included in a single device, referred to as a multifunction peripheral (MFP) or multifunction device (MFD).

Modern document processing devices frequently employ a graphical user interface wherein device status or device controls appear as indicia, such as icons, on the display. A user suitably selects a function via interaction with the display with a mouse, trackball, touchscreen, or other suitable input. More powerful document processing devices may include data storage areas or alternatively provide a gateway to data storage on a remote system, such as a workstation or file server.

Many data storage systems employ hierarchical data storage, such as file folders which are often nested within one another, and may also include electronic documents such as data files, image files, or the like. It is often difficult to navigate through such electronic files in the environment of a document processing device user interface.

### SUMMARY OF THE INVENTION

In accordance with one embodiment of the subject application, there is provided a system and method for hierarchical electronic file navigation. A plurality of electronic files are stored in an associated data storage. User identification data is received and indicia are generated corresponding to a default listing of a subset of electronic files on an associated display in accordance with received user identification data, each of which electronic file is comprised of one of an electronic document and a document folder, and wherein each indicia corresponding to an electronic document includes a thumbnail image thereof and wherein each indicia corresponding to a document folder includes a folder icon. Selection data is received from an associated user corresponding to a selected electronic folder listed on the display and indicia are generated on the display corresponding to an updated listing of electronic files corresponding to contents of the selected document folder. Shortcut selection data is received from the user corresponding to at least one selected electronic file and the at least one selected electronic file is added to the default listing in accordance with received shortcut selection data.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a hierarchical electronic file navigation system according to one embodiment of the subject application;

FIG. 2 is a block diagram illustrating device hardware for use in the hierarchical electronic file navigation system according to one embodiment of the subject application;

FIG. 3 is a functional diagram illustrating the device for use in the hierarchical electronic file navigation system according to one embodiment of the subject application;

FIG. 4 is a block diagram illustrating controller hardware for use in the hierarchical electronic file navigation system according to one embodiment of the subject application;

FIG. 5 is a functional diagram illustrating the controller for use in the hierarchical electronic file navigation system according to one embodiment of the subject application;

FIG. 6 is a diagram illustrating a server for use in the hierarchical electronic file navigation system according to one embodiment of the subject application;

FIG. 7 is a block diagram illustrating the hierarchical electronic file navigation system according to one embodiment of the subject application;

FIG. 8 is a functional diagram illustrating the hierarchical electronic file navigation system according to one embodiment of the subject application;

FIG. 9 is a flowchart illustrating a hierarchical electronic file navigation method according to one embodiment of the subject application;

FIG. 10 is a flowchart illustrating a hierarchical electronic file navigation method according to one embodiment of the subject application;

FIG. 11 is an example screen illustrating a user interface for use in the system and method for hierarchical electronic file navigation according to one embodiment of the subject application; and

FIG. 12 is an example screen illustrating a user interface for use in the system and method for hierarchical electronic file navigation according to one embodiment of the subject application.

### DETAILED DESCRIPTION OF THE PREFERRED EMBODIMENT

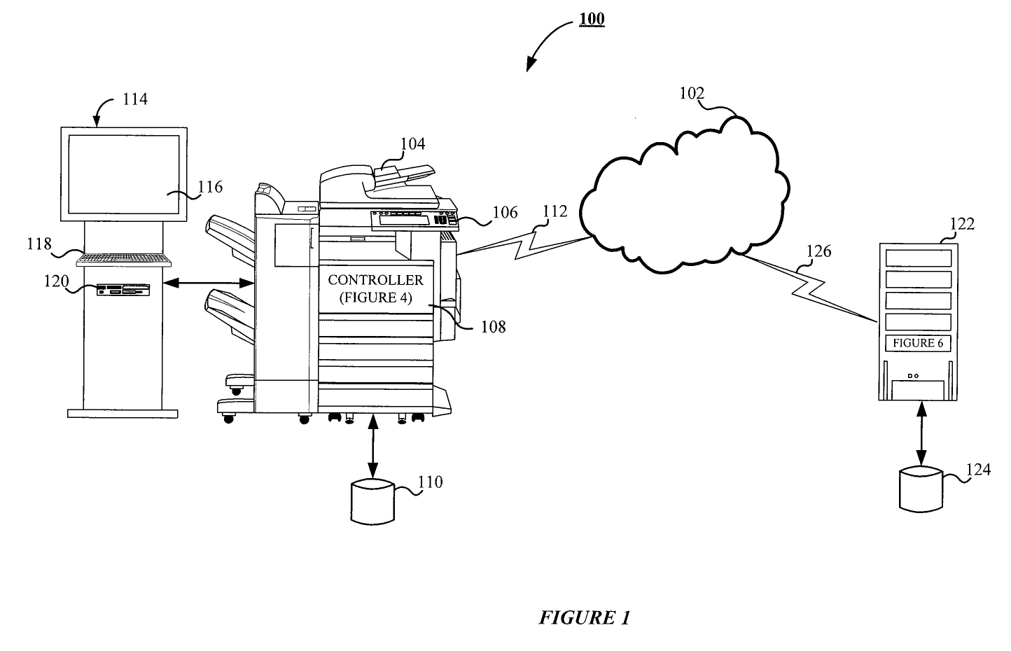

The subject application is directed to a system and method for file navigation via a graphical user interface. In particular, the subject application is directed to a system and method for efficient file selection and folder selection in connection with document processing devices. More particularly, the subject application is directed to a system and method for hierarchical electronic file navigation. It will become apparent to those skilled in the art that the system and method described herein are suitably adapted to a plurality of varying electronic fields employing file navigations, including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, shown is an overall diagram of a type system 100 for hierarchical electronic file navigation in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

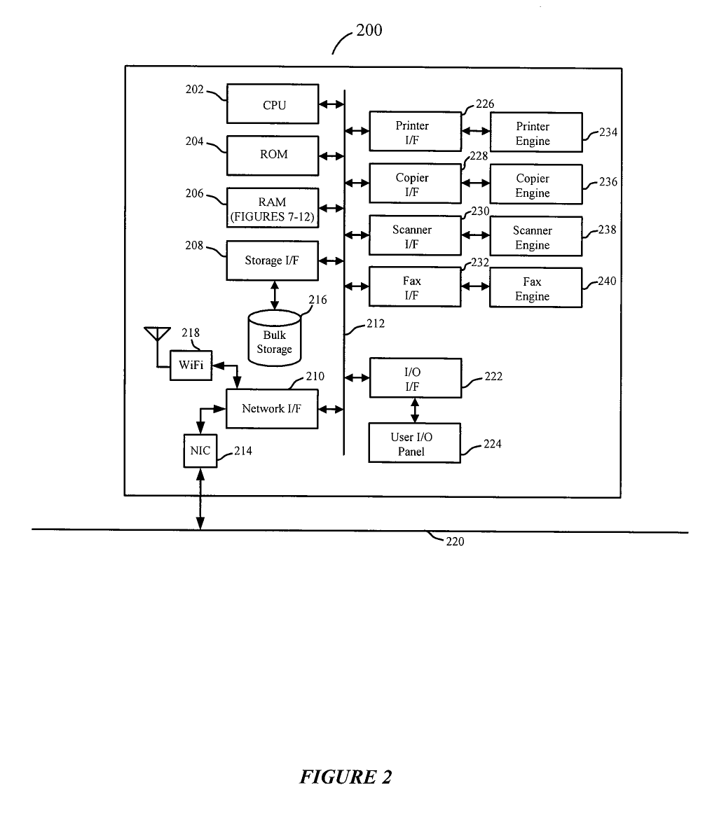

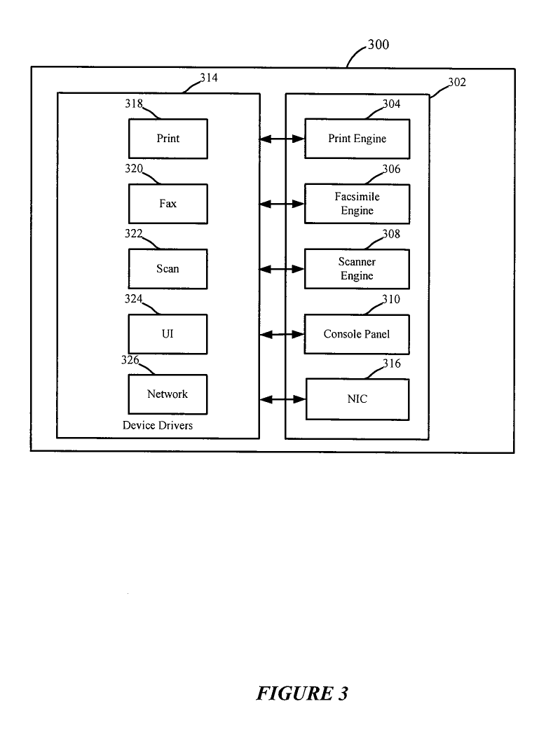

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

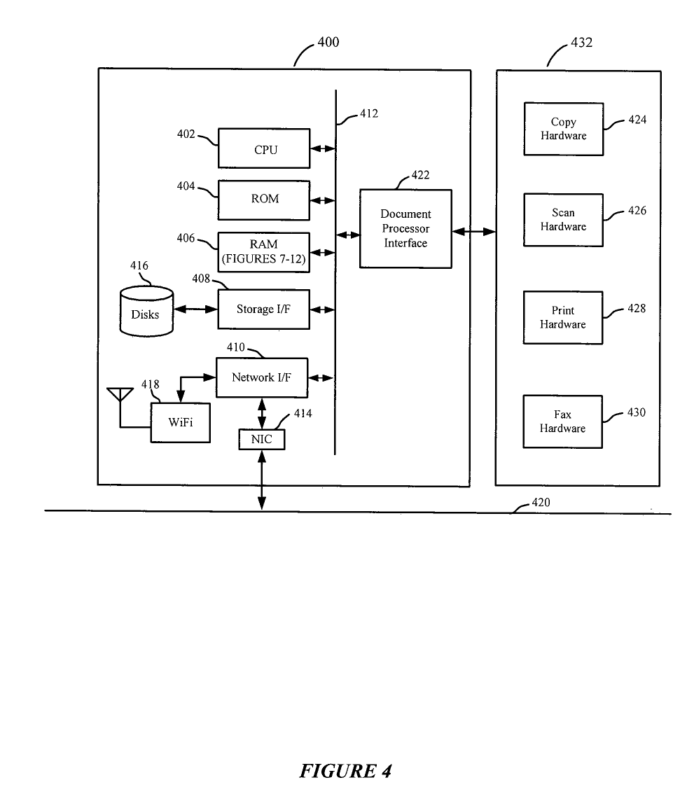

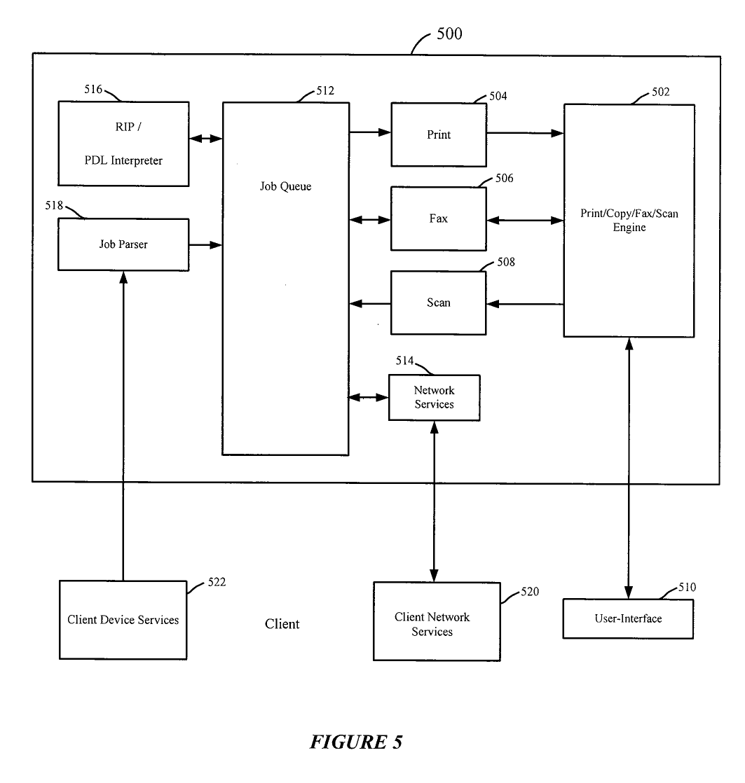

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the hierarchical electronic file navigation system and method. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a backend component, shown as the server 122, in data communication with the computer network 102 via a communications link 126. It will be appreciated by those skilled in the art that the server 122 is shown in FIG. 1 as a component of the system 100 for example purposes only, and the subject application is capable of implementation without the use of a separate backend server component. The skilled artisan will appreciate that the server 122 comprises hardware, software, and combinations thereof suitably adapted to provide one or more services, web-based applications, storage options, and the like, to networked devices. In accordance with one example embodiment of the subject application, the server 122 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102. The communications link 126 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 122 are capable of implementation on any suitable computing device coupled to the computer network 102, e.g. the controller 108, or the like.

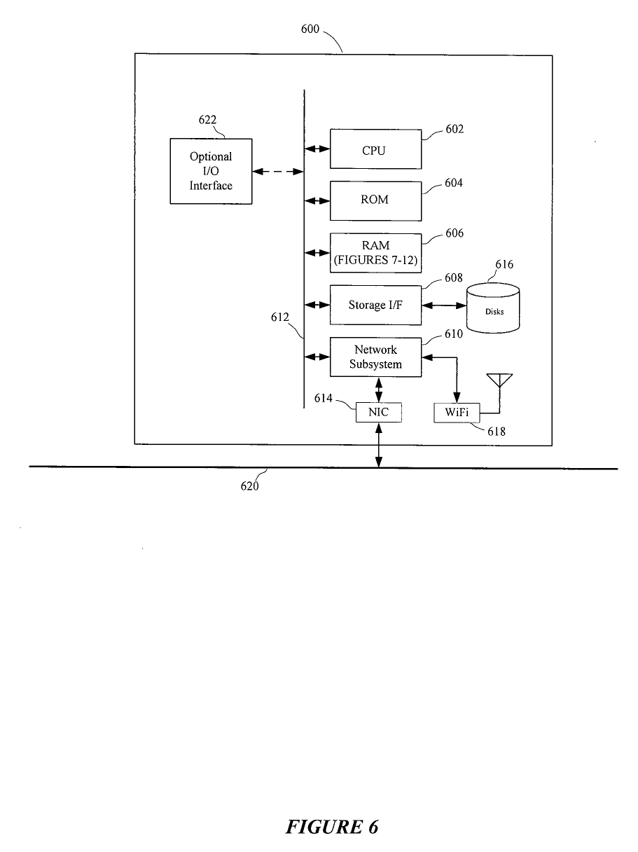

Communicatively coupled to the server 122 is the data storage device 124. According to the foregoing example embodiment, the data storage device 124 is any mass storage device, or plurality of such devices, known in the art including, for example and without limitation, magnetic storage drives, a hard disk drive, optical storage devices, flash memory devices, or any suitable combination thereof. In such an embodiment, the data storage device 124 is suitably adapted to store database entries, software updates, secured electronic documents, text data, data strings, account information, policy information, and the like. It will be appreciated by those skilled in the art that while illustrated in FIG. 1 as being a separate component of the system 100, the data storage device 124 is capable of being implemented as an internal storage component of the server 122, or the like, such as, for example and without limitation, an internal hard disk drive, or the like. In accordance with one particular embodiment of the subject application, the data storage device 124 stores lightweight directory access protocol data, such as user account information, in a plurality of searchable entries, as will be understood by those skilled in the art. The functioning of the server 122 will be better understood in conjunction with the block diagram illustrated in FIG. 6, explained in greater detail below.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 (depicted in FIG. 1 as the server 122), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art

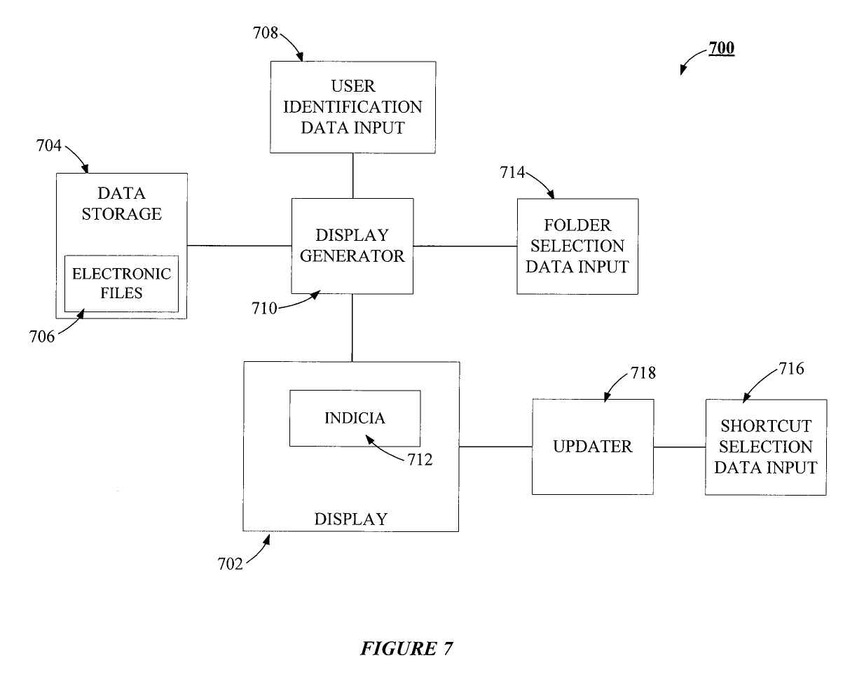

Turning now to FIG. 7, illustrated is a block diagram of a system 700 for hierarchical electronic file navigation in accordance with one embodiment of the subject application. The system 700 includes a display 702 and a data storage 704 storing a plurality of electronic files 706. The system 700 also includes a user identification data input 708 configured to receive user identification data from an associated user. The data storage 704 and the user identification data input 708 are in data communication with a display generator 710, which is configured to display indicia 712 on the display 702.

In accordance with one embodiment of the subject application, the displayed indicia 712 corresponds to a default listing of a subset of electronic files, e.g. the files 706 of the data storage 704, on the display 702 in accordance with identification data received via the input 708. Each of the electronic files 706 is either an electronic document or a document folder. Preferably, each indicia 712 corresponding to an electronic document includes a thumbnail image of the document, and each indicia 712 corresponding to a document folder includes a folder icon.

The system 700 further includes a folder selection data input 714 that is configured to receive from an associated user, selection data corresponding to a selected electronic folder listed on the display 702. The display generator 710 receives such selection data from the input 714 so as to generate indicia 712 on the display 702 corresponding to an updated listing of electronic files corresponding to contents of the selected document folder. The system 700 also includes a shortcut selection data input 716, which is configured to receive shortcut selection data from the user. Preferably, the shortcut selection data corresponds to at least one electronic file that has been selected by the associated user. Thereafter, an updater 718, in communication with the shortcut input 716 and the display 702, adds the at least one selected electronic file to the default listing on the display 702 in accordance with received shortcut selection data.

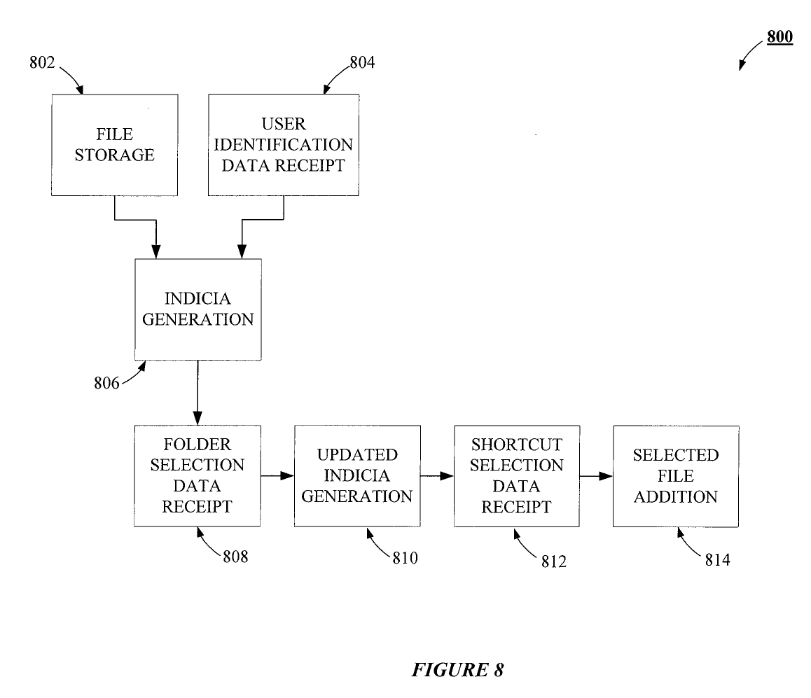

Referring now to FIG. 8, there is shown a functional diagram illustrating the system 800 for hierarchical electronic file navigation in accordance with one embodiment of the subject application. File storage 802 first occurs of a plurality of electronic files in an associated data storage. Next, identification data receipt 804 occurs of identification data corresponding to an associated user. Indicia generation 806 is then performed corresponding to a default listing of a subset of electronic files on an associated display based upon data received via 804. In accordance with one embodiment of the subject application, each of the electronic files consists of either an electronic document or a document folder. Preferably, each indicia resulting from the indicia generation 806 that corresponds to an electronic document includes a thumbnail image of the document. Similarly, each indicia resulting from the indicia generation 806 that corresponds to a document folder includes a folder icon.

Folder selection data receipt 808 then occurs from selection data from an associated user. According to one embodiment of the subject application, the selection data corresponds to a selected electronic folder that is listed on the associated display. Updated indicia generation 810 is then performed of updated indicia on the display corresponding to the updated listing of electronic files representing the contents of the selected document folder. Shortcut selection data receipt 812 then occurs from the associated user, which data corresponds to at least one selected electronic file. Thereafter, selected file addition 814 is then performed corresponding to the addition of the at least one selected electronic file to the default listing according to the data received via the shortcut selection data at 812.

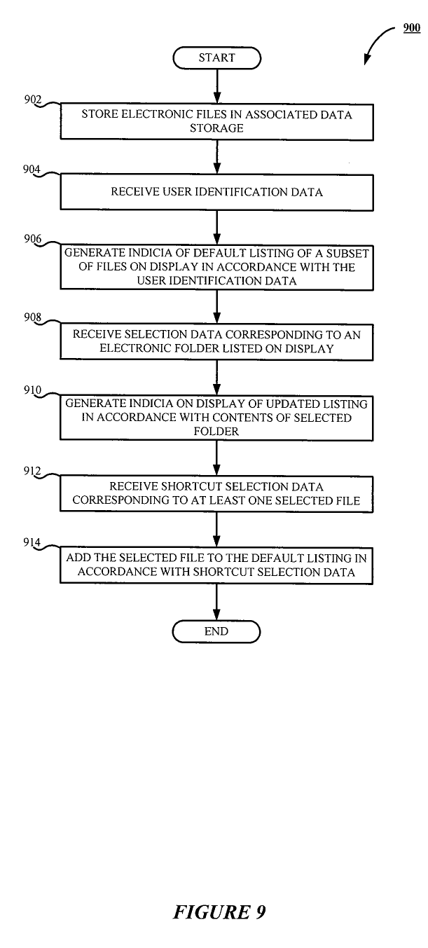

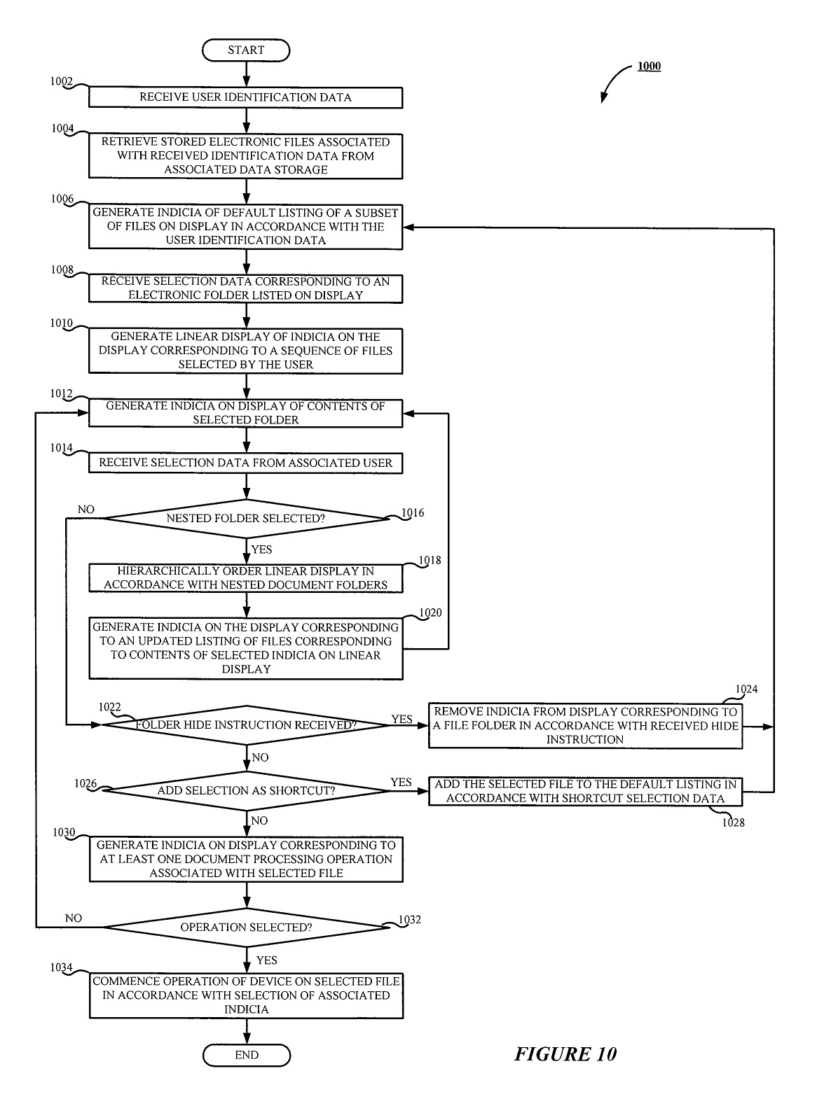

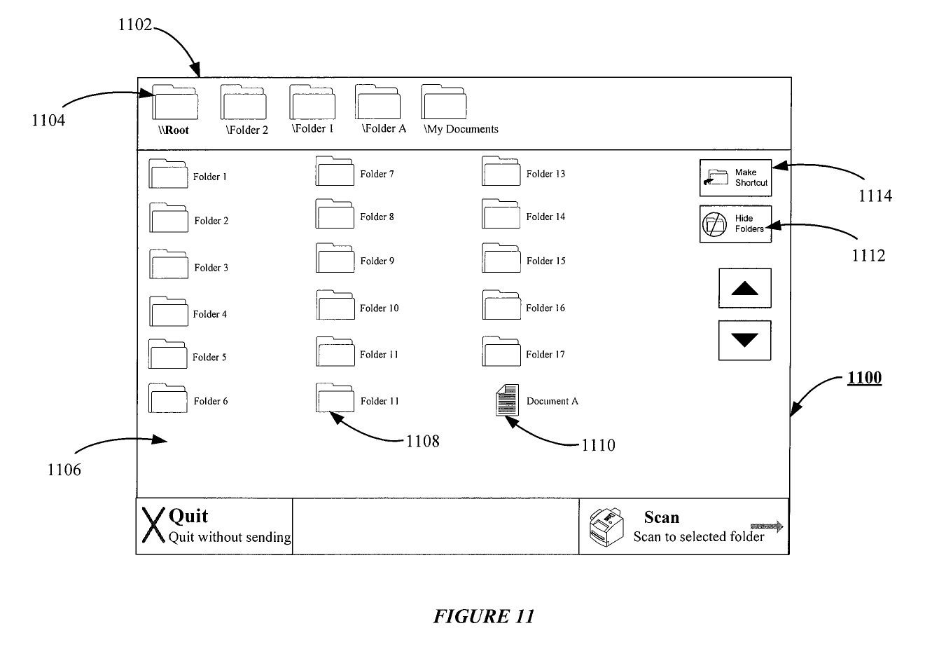

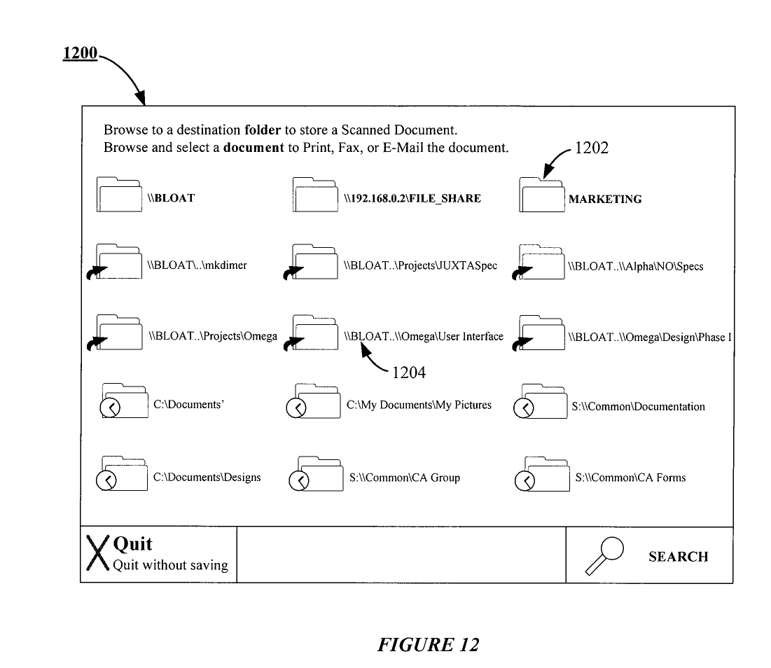

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example illustrations depicted in FIGS. 11 and 12. Turning now to FIG. 9, there is shown a flowchart 900 illustrating a hierarchical electronic file navigation method in accordance with one embodiment of the subject application.

Beginning at step 902, a plurality of electronic files are stored in an associated data storage, e.g. the data storage device 110, the data storage device 124 associated with the server 122, or the like. It will be appreciated by those skilled in the art that such files include, for example and without limitation, documents, photographs, images, spreadsheets, presentations, drawings, and the like.

At step 904, the controller 108 or other suitable component associated with the document processing device 104 receives user identification data. It will be appreciated by those skilled in the art that such receipt is capable of being accomplished via the user interface 106, the kiosk 114, or the like. Suitable user identification data includes, for example and without limitation, biometric data, username, password, smart card, or the like. At step 906, indicia of default listings of a subset of electronic files are generated on the display (user interface 106 or display 116) in accordance with the received user identification data. In accordance with one embodiment of the subject application, each of the electronic files is comprised of either an electronic document or a document folder. In such an embodiment, each indicia corresponding to an electronic document includes a thumbnail image of the document and each indicia corresponding to a document folder includes a folder icon.

Selection data is then received at step 908 corresponding to an electronic folder listed on the display 106 or 116 that is selected by the associated user. The controller 108 or other suitable component associated with the document processing device 104 then directs the generation, at step 910, of indicia on the display 106 or 116 corresponding to an updated listing of electronic files representing the contents of the selected document folder. At step 912, shortcut selection data is received from the associated user via the user interface 106, the kiosk 114, or the like. According to one embodiment of the subject application, the shortcut selection data corresponds to at least one selected electronic file from among those displayed via the user interface 106 or display 116. At step 914, the at least one selected electronic file is added to the default listing in accordance with received shortcut selection data.

Referring now to FIG. 10, there is shown a flowchart 1000 illustrating a hierarchical electronic file navigation method in accordance with one embodiment of the subject application. The methodology of FIG. 10 begins at step 1002, whereupon the controller 108 or other suitable component associated with the document processing device 104 receives user identification data from an associated user via the user interface 106, the kiosk 114, or the like. It will be understood by those skilled in the art that such identification data is capable of including, for example and without limitation, a username, password, biometric data, smart card, or the like. Stored electronic files associated with the received user identification data are then retrieved from an associated data storage at step 1004. It will be understood by those skilled in the art that the controller 108 or other suitable component associated with the document processing device 104 is capable of retrieving such stored files from the data storage device 110 associated with the device 104, from a network storage, such as the data storage 124 associated with the server 122, or the like.

At step 1006, indicia of a default listing of a subset of files retrieved in association with the user identification data are generated on the user interface 106, the display 116, or other suitable component associated with the document processing device 104. At step 1008, selection data is received from the associated user corresponding to an electronic folder listed on the display. Following selection data receipt at step 1008, flow progresses to step 1010, whereupon the controller 108 or other suitable component associated with the document processing device 104 generates a linear display of indicia on the display 106 or 116 corresponding to a sequence of files selected by the user. At step 1012, indicia are generated on the display 106 or 116 of contents associated with the selected folder. That is, the files and/or subfolders stored in the selected folder are displayed via the user interface 106 or display 116. It will be appreciated by those skilled in the art that steps 1010 and 1012 are depicted separately in FIG. 10 for example purposes only, and the skilled artisan will appreciate that the subject application is capable of simultaneously generating the linear display and contents on the user interface 106 or display 116. Turning now to FIG. 11, there is shown an example user interface 1100 that illustrates the linear display 1102 of indicia (folders 1104) in accordance with the methodology of FIG. 10. As shown in FIG. 11, the user interface 1100 includes the display 1106 of contents, depicted as nested folders 1108 and a document 1110.

Returning to FIG. 10, at step 1014, selection data is received from the associated user via the user interface 106 or kiosk 116 corresponding to a selected one of the indicia on the display 1100. A determination is then made at step 1016 whether the user has selected a nested folder 1108 or an electronic file, e.g. document 1110. Upon a determination at step 1016 that the user has selected a nested folder 1108, flow proceeds to step 1018, whereupon the linear display 1102 is hierarchically ordered in accordance with the nested document folders 1108. At step 1020, indicia are generated on the display 106 or 116 corresponding to an updated listing of files corresponding to contents of selected indicia on the linear display 1102. Following generation of the indicia on the display 106 or 116, flow returns to step 1012, whereupon the contents of the selected folder are suitable generated on the display 106 or 116, as set forth above.

Upon a determination at step 1016 that a nested folder has not been selected, flow proceeds to step 1022, whereupon a determination is made whether an instruction to hide a folder has been received from the associated user. FIG. 11 illustrates a suitable icon 1112 the selection of which would indicate an instruction to hide a selected folder 1108. When a hide instruction has been received, flow proceeds to step 1024, whereupon the indicia associated with the selected folder is removed from the interface 1100 of the display 106 or 116 in accordance with the received hide instruction. Operations then return to step 1006, for further operations in accordance with the file and folder data retrieved in accordance with the user identification data. When a folder hide instruction has not been received, flow progresses from step 1022 to step 1026. At step 1026, a determination is made whether an instruction has been received from the associated user to add a shortcut associated with the selected file. FIG. 11 illustrates a suitable icon 1114 on the interface 1100 the selection of which indicates a desire to generate a shortcut of the selected folder on the default listing of files associated with the user identification data. At step 1028, the selected file or folder is added to the default listings and flow returns to step 1006, as explained in greater detail above. FIG. 12 illustrates an example user interface 1200 displaying electronic folders 1202 and shortcuts 1204 for user selection in accordance with one embodiment of the subject application. The skilled artisan will appreciate that the user interface 1200 is capable of being displayed on the user interface 106 or the kiosk 114 associated with the document processing device 104. User selection of one of the displayed folders 1202 is capable of being accomplished via touch screen interaction of the user interface 106 or display 116, user input device 118, or the like.

Upon a determination at step 1026 that no shortcut selection has been made, flow proceeds to step 1030. At step 1030, the controller 108 or other suitable component associated with the document processing device 104 generates indicia via the user interface 106 or display 116 corresponding to at least one document processing operation associated with the selected file. That is, when no document, image, photograph, or other file has been selected, the user is presented with a scanning operation icon is displayed at step 1030 the selection of which prompts the scanning of an image to the current folder, as will be appreciated by those skilled in the art. In contrast, when a file 1110 has been selected, operations associated therewith, e.g. facsimile, print, electronic mail, or the like, are displayed to the user at step 1030. A determination is then made at step 1032 whether an operation associated with the selected file has been received from the associated user. Upon a determination that no operation has been selected, operations return to step 1012, whereupon indicia is displayed to the user indicating the contents of a selected folder. Upon a determination at step 1032 that an operation has been selected, flow proceeds to step 1034. At step 1034, operation is commenced by the document processing device 104 on the selected file in accordance with the selected operation.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A hierarchical electronic file navigation system comprising:
a display;
a data storage operable to store a plurality of electronic files;
an input operable to receive user identification data;
a display generator operable to display indicia corresponding to a default listing of a subset of electronic files on the display in accordance with received user identification data, each of which electronic files is comprised of one of an electronic document and a document folder, and wherein each indicia corresponding to an electronic document includes a thumbnail image thereof and wherein each indicia corresponding to a document folder includes a folder icon;
an input operable to receive from an associated user, selection data corresponding to a selected electronic folder listed on the display;
the display generator further operable to generate indicia on the display corresponding to an updated listing of electronic files corresponding to contents of the selected document folder;
an input operable to receive, from the associated user, shortcut selection data corresponding to at least one selected electronic file; and
an updater operable to add the at least one selected electronic file to the default listing in accordance with received shortcut selection data.

2. The system of claim 1 wherein the display generator is further operable to update display of indicia on the display corresponding to a sequence of electronic files selected by the associated user.

3. The system of claim 2 wherein each of the indicia in the linear display is selectable by the associated user, and wherein the display generator is further operable to generate indicia on the display corresponding to an updated listing of electronic files corresponding to contents of a selected indicia on the linear display.

4. The system of claim 1 further comprising:
an input means adapted operable to receive a folder hide instruction from the associated user; and
the display being further operable to remove from the display indicia corresponding to electronic files corresponding to file folders in accordance with the folder hide instruction.

5. The system of claim 1 further comprising:
the display generator further operable to generate a selectable indicia on the display corresponding to operation of an associated document processing device; and
a document processor control operable to commence operation of the associated document processing device on a selected electronic document in accordance with a selected indicia corresponding to operation of the document processing device.

6. The system of claim 2 wherein the linear display is ordered hierarchically in accordance with nested document folders.

7. A hierarchical electronic file navigation method comprising the steps of:
storing a plurality of electronic files in an associated data storage;
receiving user identification data;
generating indicia corresponding to a default listing of a subset of electronic files on an associated display in accordance with received user identification data, each of which electronic file is comprised of one of an electronic document and a document folder, and wherein each indicia corresponding to an electronic document includes a thumbnail image thereof and wherein each indicia corresponding to a document folder includes a folder icon;
receiving, from an associated user, selection data corresponding to a selected electronic folder listed on the display;
generating indicia on the display corresponding to an updated listing of electronic files corresponding to contents of the selected document folder;
receiving, from the associated user, shortcut selection data corresponding to at least one selected electronic file; and
adding the at least one selected electronic file to the default listing in accordance with received shortcut selection data.

8. The method of claim 7 further comprising the step of generating a linear display of indicia on the display corresponding to a sequence of electronic files selected by the associated user.

9. The method of claim 8 wherein each of the indicia in the linear display is selectable by the associated user, and wherein the indicia is generated on the display corresponding to an updated listing of electronic files corresponding to contents of a selected indicia on the linear display.

10. The method of claim 7 further comprising the steps of:
receiving a folder hide instruction from the associated user; and
removing indicia from the display corresponding to electronic files corresponding to a file folders in accordance with the folder hide instruction.

11. The method of claim 7 wherein:
at least one selectable indicia on the display corresponds to operation of an associated document processing device; and
the method includes the step of commencing operation of the associated document processing device on a selected electronic document in accordance with a selected indicia corresponding to operation of the document processing device.

12. The method of claim 8 wherein the linear display is ordered hierarchically in accordance with nested document folders.

13. A hierarchical electronic file navigation system comprising:
a display;
a data storage adapted to store a plurality of electronic files;
means adapted for receiving user identification data;
means adapted for generating indicia corresponding to a default listing of a subset of electronic files on the display in accordance with received user identification data, each of which electronic file is comprised of one of an electronic document and a document folder, and wherein each indicia corresponding to an electronic document includes a thumbnail image thereof and wherein each indicia corresponding to a document folder includes a folder icon;
means adapted for receiving, from an associated user, selection data corresponding to a selected electronic folder listed on the display;
display update means adapted for generating indicia on the display corresponding to an updated listing of electronic files corresponding to contents of the selected document folder;
means adapted for receiving, from the associated user, shortcut selection data corresponding to at least one selected electronic file; and
means adapted for adding the at least one selected electronic file to the default listing in accordance with received shortcut selection data.

14. The system of claim 13 further comprising means adapted for generating a linear display of indicia on the display corresponding to a sequence of electronic files selected by the associated user.

15. The system of claim 14 wherein each of the indicia in the linear display is selectable by the associated user, and wherein the display update means includes means adapted for generating indicia on the display corresponding to an updated listing of electronic files corresponding to contents of a selected indicia on the linear display.

16. The system of claim 13 further comprising:
means adapted for receiving a folder hide instruction from the associated user; and
means adapted for removing indicia from the display corresponding to electronic files corresponding to a file folders in accordance with the folder hide instruction.

17. The system of claim 13 further comprising:
at least one selectable indicia on the display corresponding to operation of an associated document processing device; and
means adapted for commencing operation of the associated document processing device on a selected electronic document in accordance with a selected indicia corresponding to operation of the document processing device.

18. The system of claim 14 wherein the linear display is ordered hierarchically in accordance with nested document folders.
